(19) United States
(12) Patent Application Publication
(10) Pub. No.: US 2023/0368259 A1
(43) Pub. Date: Nov. 16, 2023

(54) DISTRIBUTABLE CROWDSOURCABLE COMMISSION METHODS AND SYSTEMS

(71) Applicant: JORDAN CRAIG, OTTAWA (CA)

(72) Inventor: JORDAN CRAIG, OTTAWA (CA)

(21) Appl. No.: 18/313,940

(22) Filed: May 8, 2023

Related U.S. Application Data
(60) Provisional application No. 63/364,466, filed on May 10, 2022.

(51) Int. Cl. G06Q 30/0601; G06Q 20/10; G06Q 20/40

(52) U.S. Cl. CPC G06Q 30/0619; G06Q 20/102; G06Q 20/401

(57) ABSTRACT

An issue with the sale of some items is that the buyer pays the seller, an intermediary, and a fixed fee or commission are paid to the distributor and/or retailer after a significant delay or perhaps never. Accordingly, it would be beneficial to provide distributors and/or retailers with an application, system and/or platform that automates payments and/or commission payment distribution via a secure encrypted contract such as stored within a distributed ledger. Beneficially, this distributed ledger may also store secure and trustworthy digital authentication and/or rights verification. Alternatively, one ledger for the sale of an item may be combined with another distributed ledger to manage the additional financial aspects of the asset transfer. Accordingly, there are provided systems and methods for automated payments and/or commission payment distribution via one or more secure encrypted contracts.

### CROSS-REFERENCE TO RELATED APPLICATIONS

This patent application claims the benefit of priority from U.S. Provisional Patent Application 63/364,466 filed May 10, 2022; the entire contents of which are incorporated herein by reference.

### FIELD OF THE INVENTION

This patent application relates to commissions and transactions and more particularly to methods and systems for crowd-selling with distributable commissions and automated payments and commission payment distribution via distributed ledgers and/or verification of transfer of an asset arising from a transaction.

### BACKGROUND OF THE INVENTION

Typically, selling a product or service is done through a physical retail location pr through an online platform. The physical location in some instances is that of the manufacturer of the product or provider of the service or it may be a distributor and/or a retailer having a right to sell the product or provide the service. The online platform may be that of the manufacturer of the product or provider of the service, it may be the distributor and/or a retailer having a right to sell the product or provide the service, or it may be a third party (such as Amazon, eBay, Taobao, Etsy, Rakutan for example). Each of these options comes with its own set of challenges.

Typically, a distributor and/or a retailer has negotiated a discounted price to sell a product from the manufacturer. However, in some instances the distributor and/or retailer may have established a commission based sale such that they receive a fixed fee, a variable percentage of the price established with a buyer of the product or service, or a percentage of the price established with the buyer of the product or service. Fixed fee or commission based sales are typically associated with sales of art, real estate, vehicles etc. For example, with art the distributor and/or retailer may be an art gallery whilst for real estate it may be a realtor.

An issue with such sales can be that the buyer pays the seller and the fixed fee or commission are paid to the distributor and/or retailer after a significant delay or perhaps is never paid. Accordingly, it would be beneficial to provide distributors and/or retailers with an application, system and/or platform that automates payments and/or commission payment distribution via a secure encrypted contract such as stored within a distributed ledger.

Within many transactions the product sold is fake or counterfeit. This may arise as the buyer purchases a product online from a retailer or supplier who does not have the rights to the product. This may arise for the final buyer or an intermediate distributor. Accordingly, it would be beneficial to provide the final buyer and/or each intermediate distributor with a secure supply chain verification or verifiable supply chain. It would be beneficial to exploit a distributed ledger to provide a secure and trustworthy digital authentication and/or rights verification. Beneficially, this distributed ledger for secure and trustworthy digital authentication and/or rights verification may be combined with another distributed ledger or within the same distributed ledger to manage the additional financial aspects of the asset transfer with automated payments and/or commission payment distribution via one or more secure encrypted contracts.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to commissions and transactions and more particularly to methods and systems for crowd-selling with distributable commissions and automated payments and commission payment distribution via distributed ledgers and/or verification of transfer of an asset arising from a transaction.

In accordance with an embodiment of the invention there is provided a method of executing a sale comprising:
establishing an item for sale upon a web portal accessible to a group of users by a seller;
establishing by an agent an intent to promote the sale of the item in dependence upon an action by the agent with the web portal;
establishing upon another portal further content relating to the item wherein the further content is established by another action by the agent upon the web portal; and
establishing by a buyer an action with respect to the further content on the another portal to purchase the item; wherein
the agent is a user of the group of user;
the further content comprises a unique identifier associating the further content to the item; and
funds relating to the purchase of the item by the buyer are automatically distributed in dependence upon one or more smart contracts stored within a distributed ledger which are executed by a system associated with the web portal.

In accordance with an embodiment of the invention there is provided a method comprising:
automatically distributing funds relating to a sale of an item in dependence upon one or more smart contracts stored within a distributed ledger; wherein
the one or more smart contracts are established in dependence upon a unique identifier associated with the item for sale established by the system upon the item being listed for sale.

In accordance with an embodiment of the invention there is provided a system for managing an execution of a sale comprising:
a memory storing computer executable instructions for execution by a processor;
a server comprising the processor connected to a communications network;
one or more other servers also connected to the communications network; wherein
the instructions when executed by the processor configure the server to execute a process comprising the steps of:
   establishing an item for sale upon a web portal accessible to a group of users by a seller;
   establishing by an agent an intent to promote the sale of the item in dependence upon an action by the agent with the web portal;
   establishing upon another portal further content relating to the item wherein the further content is established by another action by the agent upon the web portal;
   and
   establishing by a buyer an action with respect to the further content on the another portal to purchase the item; wherein
the agent is a user of the group of user;
the further content comprises a unique identifier associating the further content to the item;
funds relating to the purchase of the item by the buyer are automatically distributed in dependence upon one or more smart contracts stored within a distributed ledger which are executed by a system associated with the web portal; and
the distributable ledger is hosted upon the one or more other servers.

In accordance with an embodiment of the invention there is provided a system for managing an execution of a sale comprising:
a memory storing computer executable instructions for execution by a processor;
a server comprising the processor connected to a communications network;
one or more other servers also connected to the communications network; wherein
the instructions when executed by the processor configure the server to execute a process comprising the step of automatically distributing funds relating to a sale of an item in dependence upon one or more smart contracts stored within a distributed ledger;
the one or more smart contracts are established in dependence upon a unique identifier associated with the item for sale established by the server upon the item being listed for sale;
the distributable ledger is hosted upon the one or more other servers.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an exemplary network environment within which configurable electrical devices according to and supporting embodiments of the invention may be deployed and operate; and

FIG. 2 depicts an exemplary wireless portable electronic device supporting communications to a network such as depicted in FIG. 1 and configurable electrical devices according to and supporting embodiments of the invention;

FIG. 3 depicts an exemplary sales flow supported by embodiments of the invention;

FIG. 4 depicts an exemplary purchase flow supported by embodiments of the invention;

FIG. 5 depicts an exemplary smart contract flow supported by embodiments of the invention;

FIG. 6 depicts an exemplary flow for removal of an item for sale upon its purchase by a buyer;

FIG. 7 depicts an exemplary flow for the processing of a sale based upon a smart contract associated with the item sold and the automated distribution of the sale proceeds;

FIG. 8 depicts an exemplary hierarchy of subsets of a crowdsourcing community wherein different subsets are able to offer a product or service for sale in advance of other subsets based upon their prior performance at selling;

FIG. 9 depicts an exemplary DCLD-SAP storefront allowing a user to indicate that they wish to function as an agent for the sale of the product where the sale is managed through a smart contract held within a decentralized ledger; and

FIG. 10 depicts a hierarchy of smart contracts for sale of an item.

### DETAILED DESCRIPTION

The present invention is directed to commissions and transactions and more particularly to methods and systems for crowd-selling with distributable commissions and automated payments and commission payment distribution via distributed ledgers and/or verification of transfer of an asset arising from a transaction.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment,” “an embodiment,” “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purposes only. It is to be understood that where the claims or specification refer to “a” or “an” element, such reference is not to be construed as there being only one of that element. It is to be understood that where the specification states that a component feature, structure, or characteristic “may,” “might,” “can” or “could” be included, that particular component, feature, structure, or characteristic is not required to be included.

Reference to terms such as “left,” “right,” “top,” “bottom,” “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including,” “comprising,” “consisting” and grammatical variants thereof do not preclude the addition of one or more components, features, steps, integers or groups thereof and that the terms are not to be construed as specifying components, features, steps or integers. Likewise, the phrase “consisting essentially of,” and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “wireless standard” as used herein and throughout this disclosure, refer to, but is not limited to, a standard for transmitting signals and/or data through electromagnetic radiation which may be optical, radio-frequency (RF) or microwave although typically RF wireless systems and techniques dominate. A wireless standard may be defined globally, nationally, or specific to an equipment manufacturer or set of equipment manufacturers. Dominant wireless standards at present include, but are not limited to IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, Bluetooth, Wi-Fi, Ultra-Wideband and WiMAX. Some standards may be a conglomeration of sub-standards such as IEEE 802.11 which may refer to, but is not limited to, IEEE 802.1a, IEEE 802.11b, IEEE 802.11g, or IEEE 802.11n as well as others under the IEEE 802.11 umbrella.

A “wired standard” as used herein and throughout this disclosure, generally refer to, but is not limited to, a standard for transmitting signals and/or data through an electrical cable discretely or in combination with another signal. Such wired standards may include, but are not limited to, digital subscriber loop (DSL), Dial-Up (exploiting the public switched telephone network (PSTN) to establish a connection to an Internet service provider (ISP)), Data Over Cable Service Interface Specification (DOCSIS), Ethernet, Gigabit home networking (G.hn), Integrated Services Digital Network (ISDN), Multimedia over Coax Alliance (MoCA), and Power Line Communication (PLC, wherein data is overlaid to AC/DC power supply). In some embodiments a “wired standard” may refer to, but is not limited to, exploiting an optical cable and optical interfaces such as within Passive Optical Networks (PONs) for example.

A “sensor” as used herein may refer to, but is not limited to, a transducer providing an electrical output generated in dependence upon a magnitude of a measure and selected from the group comprising, but is not limited to, environmental sensors, medical sensors, biological sensors, chemical sensors, ambient environment sensors, position sensors, motion sensors, thermal sensors, infrared sensors, visible sensors, RFID sensors, and medical testing and diagnosis devices.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “server” as used herein, and throughout this disclosure, refers to one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

An “application” (commonly referred to as an “app”) as used herein may refer to, but is not limited to, a “software application,” an element of a “software suite,” a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of community organizations, members of charity organizations, men and women. In its broadest sense the user may further include, but not be limited to, software systems, mechanical systems, robotic systems, android systems, etc. that may be characterised by an ability to exploit one or more embodiments of the invention. A user may also be associated through one or more accounts and/or profiles with one or more of a service provider, third party provider, enterprise, social network, social media etc. via a dashboard, web service, website, software plug-in, software application, and graphical user interface.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “profile” as used herein, and throughout this disclosure, refers to a computer and/or microprocessor readable data file comprising data relating to settings and/or limits of an adult device. Such profiles may be established by a manufacturer/supplier/provider of a device, service, etc. or they may be established by a user through a user interface for a device, a service or a PED/FED in communication with a device, another device, a server or a service provider etc.

A “computer file” (commonly known as a file) as used herein, and throughout this disclosure, refers to a computer resource for recording data discretely in a computer storage device, this data being electronic content. A file may be defined by one of different types of computer files, designed for different purposes. A file may be designed to store electronic content such as a written message, a video, a computer program, or a wide variety of other kinds of data. Some types of files can store several types of information at once. A file can be opened, read, modified, copied, and closed with one or more software applications an arbitrary number of times. Typically, files are organized in a file system which can be used on numerous different types of storage device exploiting different kinds of media which keeps track of where the files are located on the storage device(s) and enables user access. The format of a file is defined by its content since a file is solely a container for data, although, on some platforms the format is usually indicated by its filename extension, specifying the rules for how the bytes must be organized and interpreted meaningfully. For example, the bytes of a plain text file are associated with either ASCII or UTF-8 characters, while the bytes of image, video, and audio files are interpreted otherwise. Some file types also allocate a few bytes for metadata, which allows a file to carry some basic information about itself.

“Metadata” as used herein, and throughout this disclosure, refers to information stored as data that provides information about other data. Many distinct types of metadata exist, including but not limited to, descriptive metadata, structural metadata, administrative metadata, reference metadata and statistical metadata. Descriptive metadata may describe a resource for purposes such as discovery and identification and may include, but not be limited to, elements such as title, abstract, author, and keywords. Structural metadata relates to containers of data and indicates how compound objects are assembled and may include, but not be limited to, how pages are ordered to form chapters, and typically describes the types, versions, relationships and other characteristics of digital materials. Administrative metadata may provide information employed in managing a resource and may include, but not be limited to, when and how it was created, file type, technical information, and who can access it. Reference metadata may describe the contents and quality of statistical data whereas statistical metadata may also describe processes that collect, process, or produce statistical data. Statistical metadata may also be referred to as process data.

An “artificial intelligence system” (referred to hereafter as artificial intelligence, AI) as used herein, and throughout disclosure, refers to machine intelligence or machine learning in contrast to natural intelligence. An AI may refer to analytical, human inspired, or humanized artificial intelligence. An AI may refer to the use of one or more machine learning algorithms and/or processes. An AI may employ one or more of an artificial network, decision trees, support vector machines, Bayesian networks, and genetic algorithms. An AI may employ a training model or federated learning.

“Machine Learning” (ML) or more specifically machine learning processes as used herein refers to, but is not limited, to programs, algorithms or software tools, which allow a given device or program to learn to adapt its functionality based on information processed by it or by other independent processes. These learning processes are in practice, gathered from the result of said process which produce data and or algorithms that lend themselves to prediction. This prediction process allows ML-capable devices to behave according to guidelines initially established within its own programming but evolved as a result of the ML. A machine learning algorithm or machining learning process as employed by an AI may include, but not be limited to, supervised learning, unsupervised learning, cluster analysis, reinforcement learning, feature learning, sparse dictionary learning, anomaly detection, association rule learning, inductive logic programming.

“Encryption” as used herein may refer to, but is not limited to, the processes of encoding messages or information in such a way that only authorized parties can read it. This includes, but is not limited to, symmetric key encryption through algorithms such as Twofish, Serpent, AES (Rijndael), Blowfish, CASTS, RC4, 3DES, and IDEA for example, and public-key encryption through algorithms such as Diffie—Hellman, Digital Signature Standard, Digital Signature Algorithm, ElGamal, elliptic-curve techniques, password-authenticated key agreement techniques, Paillier cryptosystem, RSA encryption algorithm, Cramer-Shoup cryptosystem, and YAK authenticated key agreement protocol.

A “blockchain” (originally block chain) as used herein may refer to, but is not limited to, a representation of an embodiment of a cryptographic distributed ledger or an embodiment of a distributed ledger technology (DLT). A blockchain as used herein may refer to, but not be limited to, a continuously growing list of records, called blocks, which are linked and secured using cryptography. Each block typically contains a cryptographic hash of one or more other blocks in the chain, a timestamp and transaction data. By design, a blockchain is inherently resistant to modification of the data and provides an open, distributed ledger that can record transactions between two parties efficiently and in a verifiable and permanent way. For use as a distributed ledger, a blockchain is typically managed by a peer-to-peer network collectively adhering to a protocol for inter-node communication and validating new blocks. Once recorded, the data in any given block cannot be altered retroactively without the alteration of all subsequent blocks in the chain, which requires the collusion of the network majority. Accordingly, a blockchain is secure by design and exemplifies a distributed computing system with high Byzantine fault tolerance. Decentralized consensus has therefore been achieved with a blockchain which makes them suitable for the recording of events, medical records, and other records management activities, such as identity management, financial transaction processing, documenting provenance, food traceability, voting, etc. Within embodiments of the invention the cryptographic hash may also include a pointer (and possibly a hash) of the address of the next block in the chain.

A “distributed ledger” as used herein may refer to, but not be limited to, a database that is consensually shared and synchronized across one or more networks spread across multiple sites, institutions and/or geographies. It allows transactions to have public “witnesses,” thereby making a cyberattack more difficult. The participant at each node of the network can access the recordings shared across that network and can own an identical copy of it. Further, any changes or additions made to the ledger are reflected and copied to all participants quickly, usually within seconds or minutes. Underlying a distributed ledger technology are blockchains.

A “currency” as used herein may refer to, but not be limited to, a system of money (monetary units) in common use by a group of individuals. These may, for example, be a currency of a nation or a digital currency which may be centralized currency (i.e., issued by a government monetary authority), a decentralized currency (i.e. not a legal currency or one issued by a government monetary authority) or a decentralized currency recognized by a government monetary authority). For example, centralized currencies include, but are not limited to, the U.S. dollar (US$), European euro (€), Indian rupee ( [symbol] ), Japanese yen (¥), Chinese yuan (¥) and pounds sterling (£). For example, decentralized currencies include, but are not limited to Bitcoin, Ethereum, Litecoin, Tether, and Solano. Some cryptographic currencies, such as USD Coin for example, may be backed by a centralized currency or physical tradeable asset, e.g. gold.

“Crowdsourcing” as used herein may refer to, but not be limited to, the outsourcing or sourcing of a task, tasks, activity or activities to a group of dispersed participants who contribute to, participate in or execute the task, tasks, activity or activities. Within the scope of this patent a task, tasks, activity or activities which is outsourced may be contributed to, participated in or execute by a subset of the group of dispersed participants where this subset of the group of dispersed participants may be a single individual.

A “cryptographic currency” or “crypto currency” as used herein may refer to, but not be limited to, a digital asset designed to work as a medium of exchange that uses cryptography to secure its transactions, to control the creation of additional units, and to verify the transfer of assets. Cryptocurrencies are a type of digital currencies, alternative currencies, and virtual currencies. Cryptocurrencies use decentralized control as opposed to centralized electronic money and central banking systems. The decentralized control of each cryptocurrency works through a blockchain, which is a public transaction database, functioning as a distributed ledger.

“Self-Sovereign Identity” (SSI) as used herein may refer to, but not be limited to, a user's digital identity which allows the user to fully create and control their credential(s), without being forced to request permission of an intermediary or centralized authority and gives control over how to the user of how their personal data is shared and used. With an SSI a user has a means of generating and controlling unique identifiers as well as some facility to store identity data. An SSI may be a discrete identity stored in a decentralized manner or a decentralized identity although in its broadest it may, for example, a set of data associated with the user such as social media account data of the user, a history of transactions on an electronic commerce (e-commerce) site by the user, or a set of attestations from other individuals and/or enterprises (e.g. friends or colleagues). Accordingly, in a decentralized identity paradigm of which the SSI forms part the user is at the centre of the framework and there is no need for third parties to issue and administer an identity. However, the user may elect to have its SSI stored by a third party provider or service provider.

A “smart contract” (contract) as used herein refers to, but is not limited to, a self-executing contract with the terms of the agreement between parties, e.g. a buyer, a distributor and a seller, being directly written into lines of code. The code and the agreements contained therein being part of a distributed ledger held within a blockchain. The code controls the execution, and transactions are trackable and irreversible. A smart contract permits a trusted transaction and agreements to be conducted among disparate, anonymous parties without the need for a central authority, legal system, or external enforcement mechanism.

A “record” as used herein and throughout this disclosure, refer to, but is not limited to, information created, received, and maintained as evidence and as an asset by an organization or person, in pursuit of legal obligations or in the transaction of business.

A “transaction record” as used herein and throughout this disclosure, refer to, but is not limited to, a record documenting a transaction.

A “ledger record” or “ledger records” as used herein and throughout this disclosure, refer to, but is not limited to, a record or records containing one or more of transaction record(s), hash value(s) of transaction record(s), and reference(s) to transaction record(s) recorded on one or more distributed ledgers (e.g. blockchain) using a distributed ledger technology (DLT).

A “record system” or “records system” as used herein and throughout this disclosure, refer to, but is not limited to, an information system that captures, manages, and provides access to records over time.

A “credential” as used herein and throughout this disclosure, refers to, but is not limited to, a document or set of claims made by an issuer with respect to a qualification, competence or authority where the issuer has a relevant or de facto authority or competence to do so. With respect to cryptography a credential may take the form of one or more machine-readable cryptographic keys and/or passwords where the cryptographic credential may be self-issued, issued by a trusted third party; or in other instances the criterion for issuance is an unambiguous association of the credential with a specific, real individual or other entity.

A “verifiable credential” as used herein and throughout this disclosure, refers to, but is not limited to, a tamper-evident credential that has an authorship that can be cryptographically verified.

An “issuer” as used herein and throughout this disclosure, refers to, but is not limited to, a role an entity can perform by asserting claims about one or more subjects, creating a verifiable credential from these claims, and transmitting the verifiable credential to a holder.

A “holder” as used herein and throughout this disclosure, refers to, but is not limited to, a role an entity might perform by possessing one or more verifiable credentials and generating presentations from them.

A “verifier” as used herein and throughout this disclosure, refers to, but is not limited to, an entity verifying a claim about a given subject.

A “proof request” as used herein and throughout this disclosure, refers to, but is not limited to, a request for one or more verifiable credentials, issued by one or more issuers, held by one or more holders.

A “proof presentation” as used herein and throughout this disclosure, refers to, but is not limited to, data derived from one or more verifiable credentials, issued by one or more issuers, which is shared with a specific verifier or verifiers.

A “proof verification” as used herein and throughout this disclosure, refers to, but is not limited to, an evaluation as to whether a verifiable credential or verifiable presentation is an authentic and timely statement of the issuer or presenter, respectively.

Typically, selling a product or service is done through a physical retail location pr through an online platform. The physical location in some instances is that of the manufacturer of the product or provider of the service or it may be a distributor and/or a retailer having a right to sell the product or provide the service. The online platform may be that of the manufacturer of the product or provider of the service, it may be the distributor and/or a retailer having a right to sell the product or provide the service, or it may be a third party (such as Amazon, eBay, Taobao, Etsy, Rakutan for example). Each of these options comes with its own set of challenges.

Typically, a distributor and/or a retailer has negotiated a discounted price to sell a product from the manufacturer. However, in some instances the distributor and/or retailer may have established a commission based sale such that they receive a fixed fee, a variable percentage of the price established with a buyer of the product or service, or a percentage of the price established with the buyer of the product or service. Fixed fee or commission based sales are typically associated with sales of art, real estate, vehicles etc. For example, with art the distributor and/or retailer may be an art gallery whilst for real estate it may be a realtor.

An issue with such sales can be that the buyer pays the seller and the fixed fee or commission are paid to the distributor and/or retailer after a significant delay or perhaps is never paid. Accordingly, it would be beneficial to provide distributors and/or retailers with an application, system and/or platform that automates payments and/or commission payment distribution via a secure encrypted contract such as stored within a distributed ledger.

Within many transactions the product sold is fake or counterfeit. This may arise as the buyer purchases a product online from a retailer or supplier who does not have the rights to the product. This may arise for the final buyer or an intermediate distributor. Accordingly, it would be beneficial to provide the final buyer and/or each intermediate distributor with a secure supply chain verification or verifiable supply chain. It would be beneficial to exploit a distributed ledger to provide a secure and trustworthy digital authentication and/or rights verification. Beneficially, this distributed ledger for secure and trustworthy digital authentication and/or rights verification may be combined with another distributed ledger or within the same distributed ledger to manage the additional financial aspects of the asset transfer with automated payments and/or commission payment distribution via one or more secure encrypted contracts.

Accordingly, embodiments of the invention provide for either a distributed ledger for secure and trustworthy digital authentication and/or rights verification, a distributed ledger for automated payments and/or commission payment distribution via one or more secure encrypted contracts, or a distributed ledger providing secure digital authentication and/or rights verification with automated payments and/or commission payment distribution via one or more secure encrypted contracts.

Whilst within the following description embodiments of the invention are described with respect to the sale/purchase of art and commissions associated with such sales/purchases it would be evident to one of skill in the art that the embodiments of the invention may be applied to other assets that are sold/purchased with a fixed and/or commission based sale such as, for example, physical assets (e.g. real estate, jewelry, vehicles, electronic equipment, food, beverages, etc.), electronic content, a computer file, metadata, user information, and biometric information or combinations thereof. It would also be evident to embodiments of the invention may be applied to other assets that are sold/purchased for a fixed fee. This fixed fee may be viewed in some embodiments of the invention as a variable commission that is defined at the point of sale based upon the final sale price.

Within other embodiments of the invention a commission may be initially associated with the item but may be subsequently split between two or more beneficiaries according to agreements in place between them. For example, an artist may agree to have a gallery sell their work for a commission of 50% but the gallery in order to increase its “net” of potential buyers grants other galleries rights to sell on the basis that the original gallery and these secondary galleries split the commission equally although in other instances the split may be not equal.

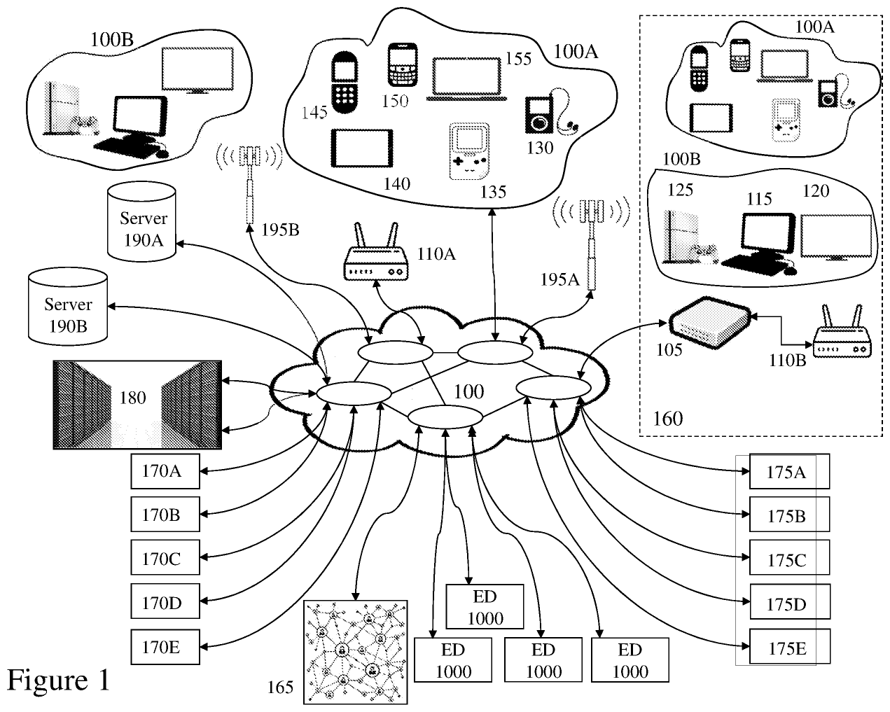

Referring to FIG. 1 there is depicted a Network 100 within which embodiments of the invention may be employed supporting Decentralized Ledger Commission Distribution (DLCD) Systems, Applications and Platforms (DLCD-SAPs) according to embodiments of the invention. Such DLCD-SAPs, for example, supporting multiple communication channels, dynamic filtering, etc. As shown first and second user groups 100A and 100B respectively interface to a telecommunications Network 100. Within the representative telecommunication architecture, a remote central exchange 180 communicates with the remainder of a telecommunication service providers network via the Network 100 which may include for example long-haul OC-48/OC-192 backbone elements, an OC-48 wide area network (WAN), a Passive Optical Network, and a Wireless Link. The central exchange 180 is connected via the Network 100 to local, regional, and international exchanges (not shown for clarity) and therein through Network 100 to first and second cellular APs 195A and 195B respectively which provide Wi-Fi cells for first and second user groups 100A and 100B respectively. Also connected to the Network 100 are first and second Wi-Fi nodes 110A and 110B, the latter of which being coupled to Network 100 via router 105. Second Wi-Fi node 110B is associated with an Original Equipment Manufacturer 160 comprising other first and second user groups 100A and 100B. Second user group 100B may also be connected to the Network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the Network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the Network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 or Bluetooth as well in an ad-hoc manner.

Also connected to the Network 100 are one or more Social Networks/Social Media (SOCNETs/SOMEs) 165, first and second service providers 170A and 170B respectively, first and second third party service providers 170C and 170D respectively, and a User 170E. Also connected to the Network 100 are first and second Enterprises 175A and 175B respectively, first and second Organizations 175C and 175D respectively, and a Government Entity 175E. Each of first and second Enterprises 175A and 175B respectively, first and second Organizations 175C and 175D respectively, and Government Entity 175E may be an enterprise, a service provider, a third-party provider or a combination thereof.

Also depicted are first and second Servers 190A and 190B may host according to embodiments of the inventions multiple services associated with a provider of Decentralized Ledger Commission Distribution (DLCD) Systems, Applications and Platforms (DLCD-SAPs); a provider of a SOCNET or Social Media (SOME) exploiting DLCD-SAP features; a provider of a SOCNET and/or SOME not exploiting DLCD-SAP features; a provider of services to PEDS and/or FEDS; a provider of one or more aspects of wired and/or wireless communications; an Original Equipment Manufacturer 160 exploiting DLCD-SAP features; license databases; content databases; image databases; content libraries; customer databases; websites; and applications for download to or access by FEDs and/or PEDs exploiting and/or hosting DLCD-SAP features. First and second Servers 190A and 190B may also host for example other Internet services such as a search engine, financial services, third party applications and other Internet based services.

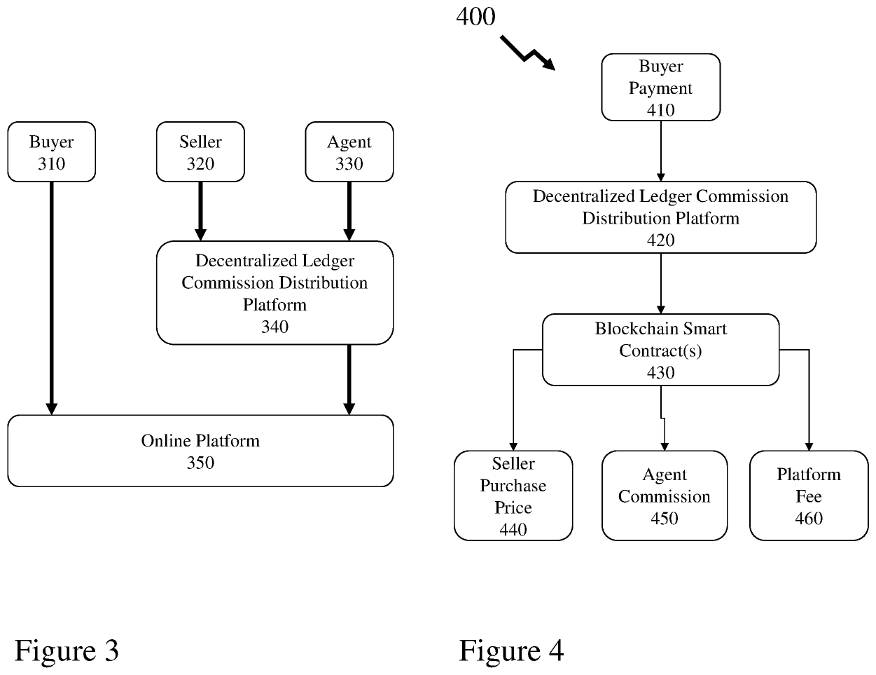

Also depicted in FIG. 1 are Electronic Devices (EDs) 100 according to embodiments of the invention such as described and depicted below in respect of FIGS. 3 to 9. As depicted in FIG. 1 the EDs 1000 communicate directly to the Network 100. The EDs 1000 may communicate to the Network 100 through one or more wireless or wired interfaces included those, for example, selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, a user may exploit a PED and/or FED within an Original Equipment Manufacturer 160, for Servers 190A and 190B respectively to perform an operation such as accessing/downloading an application which provides DLCD-SAP features according to embodiments of the invention; execute an application already installed providing DLCD-SAP features; execute a web based application providing DLCD-SAP features; or access content. Similarly, a user may undertake such actions or others exploiting embodiments of the invention exploiting a PED or FED within first and second user groups 100A and 100B respectively via one of first and second cellular APs 195A and 195B respectively and first Wi-Fi nodes 110A. It would also be evident that a user may, via exploiting Network 100 communicate via telephone, fax, email, SMS, social media, etc.

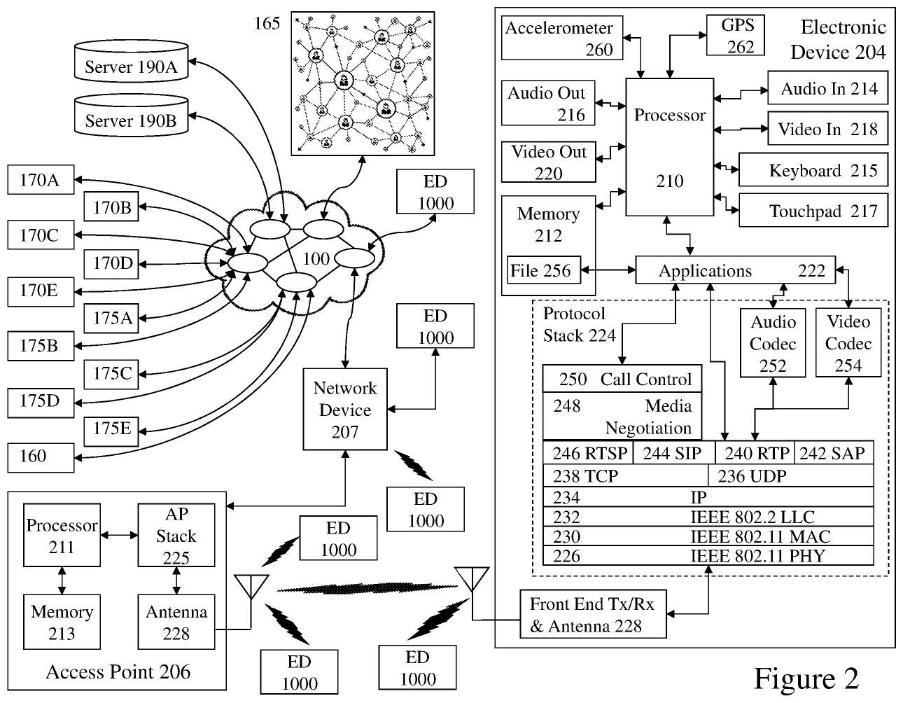

Now referring to FIG. 2 there is depicted an Electronic Device 204 and network access point 207 supporting DLCD-SAP features according to embodiments of the invention. Electronic Device 204 may, for example, be a PED, a FED or a Wearable Device and may include additional elements above and beyond those described and depicted. Also depicted within the Electronic Device 204 is the protocol architecture as part of a simplified functional diagram of a system 200 that includes an Electronic Device 204, such as a smartphone 155, an access point (AP) 206, such as first AP 110, and one or more network devices 207, such as communication servers, streaming media servers, and routers for example such as first and second Servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to Network 100 and therein one or more Social Networks/Social Media (SOCNETs/SOMEs) 165, first and second service providers 170A and 170B respectively, first and second third party service providers 170C and 170D respectively, a User 170E, first and second Enterprises 175A and 175B respectively, first and second Organizations 175C and 175D respectively, and a Government Entity 175E. Each of first and second Enterprises 175A and 175B respectively, first and second Organizations 175C and 175D respectively, and Government Entity 175E may be an enterprise, a service provider, a third-party provider or a combination thereof.

The Electronic Device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic Device 204 may include an audio input element 214, for example a microphone, and an audio output element 216, for example, a speaker, coupled to any of processors 210. Electronic Device 204 may include a video input element 218, for example, a video camera or camera, and a video output element 220, for example an LCD display, coupled to any of processors 210. Electronic Device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the Electronic Device 204. The one or more applications 222 that are typically stored in memory 212 and are executable by any combination of processors 210. Electronic Device 204 also includes accelerometer 260 providing three-dimensional motion input to the process 210 and GPS 262 which provides geographical location information to processor 210.

Electronic Device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the Electronic Device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by Electronic Device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Also depicted in FIG. 2 are Electronic Devices (EDs) 100 according to embodiments of the invention such as described and depicted below in respect of FIGS. 3 to 9. As depicted in FIG. 2 an EDs 1000 may communicate directly to the Network 100. Other EDs 1000 may communicate to the Network Device 207, Access Point 206, and Electronic Device 204. Some EDs 1000 may communicate to other EDs 1000 directly. Within FIG. 2 the EDs 1000 coupled to the Network 100 and Network Device 207 communicate via wired interfaces. The EDs 1000 coupled to the Access Point 206 and Electronic Device 204 communicate via wireless interfaces. Each ED 100 may communicate to another electronic device, e.g. Access Point 206, Electronic Device 204 and Network Device 207, or a network, e.g. Network 100. Each ED 100 may support one or more wireless or wired interfaces including those, for example, selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, FIG. 2 depicts an Electronic Device 204, e.g. a PED, wherein one or more parties including, but not limited to, a user, users, an enterprise, enterprises, third party provider, third party providers, wares provider, wares providers, financial registry, financial registries, financial provider, and financial providers may engage in one or more transactions relating to an activity including, but not limited to, e-business, P2P, C2B, B2B, C2C, B2G, C2G, P2D, and D2D via the Network 100 using the electronic device or within either the Access Point 206 or Network Device 207 wherein details of the transaction are then coupled to the Network 100 and stored within remote servers, such as first and second Servers 190A and 190B

Optionally, rather than wired and/or wireless communication interfaces devices may exploit other communication interfaces such as optical communication interfaces and/or satellite communications interfaces. Optical communications interfaces may support Ethernet, Gigabit Ethernet, SONET, Synchronous Digital Hierarchy (SDH) etc. An ED 1000 according to embodiments of the invention may represent a wearable device providing information to another ED 1000 such as another wearable device, PED, or FED for example.

Within DLCD-SAPs according to embodiments of the invention an ED 1000 may store additional information relating to the user including, for example, a user profile, user information, a computer file, and electronic content. Accordingly, the ED 1000 may employ this additional information such that within DLCD-SAPs according to embodiments of the invention a DLCD-SAP may encrypt some or all of the additional information into a blockchain or distributed ledger and/or encrypt information into a blockchain or distributed ledger using this additional information.

Within DLCD-SAPs according to embodiments of the invention an ED 1000 may contain one or more sensors. For example, a sensor may include, but not be limited to, a biometric sensor, an environmental sensor, a medical sensor, a biological sensor, a chemical sensor, an ambient environment sensor, a position sensor, a motion sensor, a thermal sensor, an infrared sensor, a visible sensor, a RFID sensor, and a medical testing and diagnosis device. Accordingly, the ED 1000 may employ the data from the sensor(s) and may encrypt some or all of the additional information into a blockchain or distributed ledger and/or encrypt information into a blockchain or distributed ledger using this additional information.

Referring to FIG. 3 there is depicted an exemplary sales flow supported by embodiments of the invention. As depicted a Buyer 310 accesses an Online Platform 350, an embodiment of a DLCD-SAP according to an embodiment of the invention, in order to search for a product they wish to purchase. The product they select having been previously established upon the Online Platform 350 by a Seller 320 and/or Agent 330 through a Decentralized Ledger Commission Distribution Platform 340. Optionally, the Seller 320 may have placed the product for sale themselves, the Agent 330 may have placed the product for sale based upon an agreement with the Seller 320 to function as their agent, or the Agent 330 seeks to sell the product without a formal agreement with the Seller 320.

Accordingly, a Seller 320 creates an account with the DLCD-SAP (Online Platform 350) and uploads a photograph, price, and description of the product, along with shipping information. The Online Platform 350 may be associated, for example with a SOCNET/SOME 165, first service provider 170A, second service provider 170B, first third party service provider 170C, second third party service provider 170D, first Enterprise 175A, second Enterprise 175B, first Organization 175C, second Organization 175D or a Government Entity 175E, for example, supporting an electronic commerce website (e-commerce site). The Seller 320 upon uploading the product to the Online Platform 350 (DLCD-SAP) may establish a commission to be associated with an Agent 330 who helps the Seller 320 sell the product. Whilst the Agent 330 may be associated with the Seller 330 they may, within embodiments of the invention, be anyone interested in promoting and making money from commission on a product registered with the DLCD-SAP. As such an Agent 330 may or may not have a formalized relationship with the Seller 320.

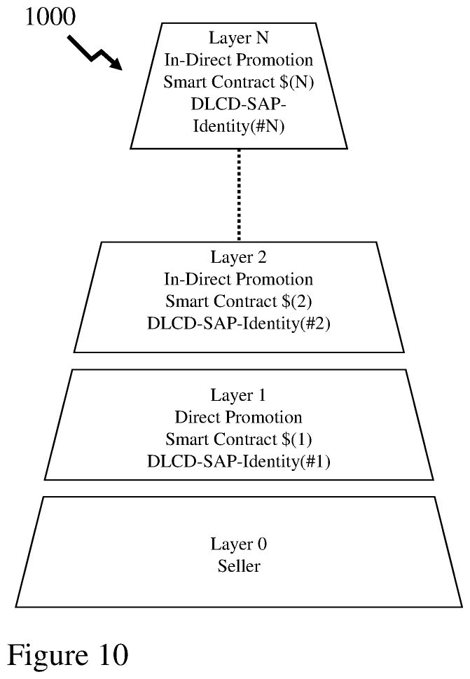

However, when the Seller 320 has a formalized relationship with an Agent 330 who places the item for sale upon the DLCD-SAP then the Agent 330 in this instance may be viewed from the perspective of the processes and logical flows of the DLCD-SAP as being the Seller 320 and the Agent 330 is then anyone interested in promoting and making money from commission for the product. As will become evident within the following description this hierarchy can extend further where each individual or enterprise within a level of the hierarchy obtains a payment from the sale of a product upon the DLCD-SAP based upon the commission a previous Agent 330 within the hierarchy elects to offer up for the next Agent 330 down the hierarchy. This being described below with respect to FIG. 10.

An Agent 330 can choose from any available product on the DLCD-SAP, elects to promote the product, and upon electing to promote the product is provided with electronic content to employ in promoting the product. This electronic content may include a hyperlink (link) for example or a script for generating a “webpage” that renders an image of the product etc. with required links for the DLCD-SAP to manage the overall processes according to embodiments of the invention. This promotion may be upon the Agent's 330 social media platform(s) or it may be another one of the first service provider 170A, second service provider 170B, first third party service provider 170C, second third party service provider 170D, first Enterprise 175A, second Enterprise 175B, first Organization 175C, second Organization 175D and Government Entity 175E.

This electronic content is associated with a unique DLCD-SAP commission number allowing associations of the sale to one or more blockchain based smart contracts that manage the automatic distribution of the commissions and sale proceeds etc. as described with respect to embodiments of the invention. Accordingly, a Buyer 310 upon seeking to purchase the product accesses electronic content which has associated with it the unique DLCD-SAP commission number such that the DLCD-SAP can extract the associate one or more smart contracts upon payment being completed by the Buyer 310 and proceed to execute the terms of the one or more smart contracts. As described below with tiered commissions the unique DLCD-SAP commission number and its associated one or more smart contracts may reference other DLCD-SAP commission numbers and therein their associated smart contracts.

Accordingly, within an embodiment of the invention a Seller 320 may initially promote a product wherein an Agent 330 then promotes the item. The Buyer 310 sees the Agent's 330 promotion and purchases the product. Financial aspects of the transaction are then managed by the smart contract(s). Within this embodiment of the invention the smart contract associated with the activity between the Seller 320 and Agent 330 may limit the re-promotion of the product such that any other entity re-promoting does not benefit financially. As such the DLCD-SAP hierarchy for this consists of two layers, Layer 0 for the Seller 320 and Layer 1 for the Agent 330 who is directly promoting the product.

It would be evident, however, that if the Buyer 310 purchased the product from the Seller 320 then all other smart contracts are null and void. However, the intent of embodiments of the invention is to leverage crowd-sourcing to sales (what the inventor refers to as crowd-selling) such that a Seller 320 can obtain a wider sales channel than they might otherwise be able to establish. For example, a Seller 320 placing a painting upon a prior art platform such as eBay™ for example, must hope that a Buyer 330 finds their posting of the item amongst the over 590,000 postings for paintings (May 4, 2022).

However, as Agents 330 can be numbered in tens, hundreds, thousands or tens of thousands across multiple platforms (including but not limited to SOCNETs/SOMEs, first service providers 170A, second service providers 170B, first third party service providers 170C, second third party service providers 170D, first Enterprises 175A, second Enterprises 175B, first Organizations 175C, second Organizations 175D and even Government Entities 175E) then the Buyer 330 may identify the product from any of these sources. Further, as the Buyer 330 may see the product within their SOCNETs/SOMEs they may not even be actively searching for the product before being exposed to its availability.

Within another embodiment of the invention a Seller 320 may initially promote a product wherein an Agent 330 then promotes the item. Subsequently, a further Agent 330 re-promotes based upon the initial posting from the Seller 320. As the further Agent 330 has re-promoted directly from the Seller 320 then if the Buyer 310 sees the further Agent's 330 promotion and purchases the product then the financial aspects of the transaction are then managed by the smart contract(s) under the same terms as that as if the Agent 330 who initially posted was the entity the Buyer 310 purchased through. Within this embodiment of the invention the smart contract(s) associated with the activities between the Seller 320, the Agent 330 and further Agent 330 may limit the re-promotion of the product such that any other entity re-promoting without a direct association with the Seller 320 does not benefit financially. As such the DLCD-SAP hierarchy for this consists of two layers, Layer 0 for the Seller 320 and Layer 1 for the Agent 330 and further Agent 330 who are directly promoting the product. Accordingly, multiple Agents 330 can establish a smart contract for promoting the product through an association with the Seller 320 within the DLCD-SAP.

Within another embodiment of the invention a Seller 320 may initially promote a product wherein an Agent 330 then promotes the item. Within this embodiment of the invention the smart contract(s) associated with the activities between the Seller 320 and the Agent 330 allow for re-promotion of the product such that a further entity, a further Agent 330, can re-promote without a direct association through an association with the posting of the Agent 330 and benefit financially if the Buyer 310 purchases the product from them. Accordingly, the further Agent 330 re-promotes based upon the posting from the Agent 330 where this re-promotion is now governed by one or more further smart contracts wherein the financial aspects of the transaction between Buyer 310 and further Agent 330 are then managed by the smart contracts, a first subset of these being those between the further Agent 330 and Agent 300, and a second subset of these being those between the Seller 310 and the Agent 330. As such the DLCD-SAP hierarchy for this consists of three layers, Layer 0 for the Seller 320, Layer 1 for the Agent 330, and Layer 2 for the further Agent 330.

Accordingly, multiple Agents 330 can establish smart contracts for promoting the product through an association with the Seller 320 within the DLCD-SAP and multiple further Agents 330 can establish smart contracts for promoting the product through associations with Agents 330 within the DLCD-SAP. The terms of the smart contract(s) between Layer 0 (Seller 320) and Layer 1 (Agents 330) defining a commission for the sale of the product and accordingly the percentage of the sales price the Seller 320 obtains. However, now the terms of the other smart contract(s) between Layer 1 (Agents 330) and Layer 2 (further Agents 330) define how the commission established by the smart contract(s) for the sale of the product between Layer 0 (Seller 320) and Layer 1 (Agents 330) is split between the Agent 330 in Layer 1 and the further Agent in Layer 2. Accordingly, the percentage of the sales price the Seller 320 obtains is defined by the initial smart contract(s) with the Agent 330 for the channel through which the actual sale to the Buyer 330 is promoted.

Within embodiments of the invention the smart contract(s) between Layer 0 (Seller 320) and Layer 1 (Agents 330) may have the same commission terms. Within other embodiments of the invention the Seller 320 may establish different smart contracts with different Agents 330 such that the commission terms between the Seller 320 in Layer 0 and different Agents 330 in Layer 1 may have different terms.

Similarly, within embodiments of the invention the smart contract(s) between an Agent 330 in Layer 1 and the further Agents 330 established by the Agent 330 may have the same commission terms. Within other embodiments of the invention the Agent 330 may establish different smart contracts with different further Agents 330 such that the commission terms between an Agent 330 in Layer 1 and different further Agents 330 in Layer 2 may have different terms.

It would be evident that a further Agent 330 in Layer 2 may establish multiple smart contracts with different Agents 330 in Layer 1 for the same product from the seller in Layer 0. For example, in a non-limiting example the Seller 320 sets a commission of 50%, a first Agent 330 sets a similar commission of 50% such that the further Agent 330 would obtain 25% of the sale price, the first Agent 330 25% of the sale price and the Seller 50%. However, a second Agent 330 may set a commission of 25% such that the further Agent 330 would obtain 37.5% (75% of 50%) of the sale price, the first Agent 330 12.5% (25% of 50%) of the sale price and the Seller 50%. The further Agent 330 may swap their posts from first Agent 330 to second Agent 330 or they may promote the sale on one channel with the posting from first Agent 330 and its associated smart contact(s) and promote the same on another channel with the posting from second Agent 330 and its associated smart contact(s). However, as each posting is intrinsically linked through a unique identity within the DLCD-SAP then the further Agent 330 may in fact promote the sale from both first Agent 330 and second Agent 330 on the same channel and the DLCD-SAP will automatically process the commissions etc. as outlined below through the smart contracts.

Within embodiments of the invention the unique identity of the product being sold within the DLCD-SAP may be encoded within the content posted. Within other embodiments of the invention the unique identity of the product being sold within the DLCD-SAP may be encoded within a hyperlink which links the Buyer 310 from posted content to a sales portal of the DLCD-SAP. These unique identities are coded into the smart contract(s) which are stored within a block within a blockchain or other distributed ledger.

Within other embodiments of the invention each subsequent posting of content initially posted by the Seller 320 onto the DLCD-SAP by an action of an Agent 330 results in a new unique identity being generated by the DLCD-SAP such that this new unique identity is a combination of a first unique identity of the product being sold and a second unique identity of the Agent 330 re-posting. These new unique identities are coded into the smart contract(s) which are stored within a block within a blockchain or other distributed ledger. Alternatively, the new unique identity may point to a block within a blockchain or other distributed ledger which contains the first unique identity and the second unique identity. It would be evident to one of skill in the art that these concepts as just described relate to a sale with 2-layers (e.g., the Seller 320 in Layer 0 and Agent 330 in Layer 1) but that these concepts can be extended to 3-layers (e.g., the Seller 320 in Layer 0, the Agent 330 in Layer 1 and further Agent 330 in Layer 2), 4-layers etc.

Within other embodiments of the invention the first unique identity of the product being sold and the second unique identity of the Agent 330 promoting may be rendered within each posting/promotion made by the Agent 330. However, in this instance the Buyer 330 enters them into the sale process within the DLCD-SAP. Accordingly, the Buyer 330 may buy from an Agent 330 based upon their selection of the Agent 330 from multiple instances of the promotion from multiple Agents 330 even if they do not current have the specific promotion from the Agent 330 they wish to employ open within a browser. Optionally, the Buyer 330 could speculatively enter the first unique identity of the product being sold and the second unique identity of the Agent 330 for a product they wish to purchase to see if that specific Agent 330 they prefer to purchase from has the product for sale.

It would be evident that through the DLCD-SAP and the smart contracts that whilst the number of agents may be large the sale to a buyer is based upon the first transaction registered within the blockchain. Whilst in many instances this may provide a level field some benefit may be derived from the DLCD-SAP where Agents 330 also can “mine” or verify new transactions.

Within embodiments of the invention the smart contract(s) automatically manage all financial aspects of the sale such that the financial distribution from Buyer 310 to Seller 320 and Agent(s) 330 is automatically managed by the DLCD-SAP and the smart contract(s) such that issues with respect to Agents 330 holding sale proceeds for extended periods of time before paying the Seller 320 are removed.

Within other embodiments of the invention the smart contract(s) automatically managing the financial aspects of the sale are such that the financial distribution is initially made from Buyer 310 to Seller 320 and then the distribution to the Agent(s) 330 is performed. Within other embodiments of the invention the smart contract(s) automatically managing the financial aspects of the sale are such that the financial distribution is initially made from Buyer 310 to Seller 320 but the subsequent distribution to the Agent(s) 330 is performed under direction of the Seller 320 either through an action of the Seller 320, automatically after a predetermined time period, or automatically after verification of payment into a financial account associated with the Seller 320 is obtained, or automatically after a predetermined time period after verification of payment into a financial account associated with the Seller 320 is obtained.

Within embodiments of the invention aspects such as delivery of the product to the Buyer 310 may be managed according to different scenarios as known in the art. For example:
the Seller 320 may manage shipping directly to the Buyer 330 where costs are covered by the Seller 320;
the Seller 320 may manage shipping directly to the Buyer 330 where costs are covered by the Buyer 310 (which may employ an additional feature of the DLCD-SAP and additional smart contracts for example);
the Buyer 330 may be responsible for managing shipping costs and arranging pick-up from the Seller 310;
the Agent 320 may have the product and may manage shipping directly to the Buyer 310 where costs are covered by the Agent 330;
the Agent 320 may have the product and may manage shipping directly to the Buyer 310 where costs are covered by the Buyer 310 (which may employ an additional feature of the DLCD-SAP and additional smart contracts for example);
the Buyer 310 may be responsible for managing shipping costs and arranging pick-up from the Agent 320.

It would be evident that a DLCD-SAP according to embodiments of the invention allows anyone to become an Agent online, for example for their own personal favorite products, and leverage their SOCNETs/SOMEs into a storefront. Accordingly, anyone can promote a product to their friend(s) and get commission when their friend(s) purchase. Whilst the embodiments of the invention may be written as or interpreted as being based upon an Agent being an individual it would however be evident that an Agent may include, but not be limited to:
a first service provider 170A;
a second service provider 170B;
a first third party service provider 170C;
a second third party service provider 170D;
a first Enterprise 175A;
a second Enterprise 175B;
a first Organization 175C;
a second Organization 175D; and
a Government Entity 175E.

It would be evident that a DLCD-SAP according to embodiments of the invention supports Agents from individuals up to multinational enterprises. Accordingly, an individual may sell through their social media, an individual may create their own online storefront, through their own e-commerce site, etc. Alternatively, a DLCD-SAP according to embodiments of the invention may be integrated with an existing online retailer website etc.

By way of a non-limiting example, Ted (an artist) has just finished a new painting that he would like to sell. Ted creates a profile on the DLCD-SAP and uploads one or more images of the painting, together with shipping information, and price (e.g., US$10,000). The user's profile upon the DLCD-SAP may include information relating to one or more financial accounts of the user to which proceeds from a sale can be transferred. This may be, for example, a bank account, a credit card, or a cryptocurrency account. Ted also establishes a commission of 10% for the sale of the painting. Lisa (a college student) decides she would like to earn a little extra money and has friends that enjoy artwork. She visits the DLCD-SAP website and sees Ted's painting and really loves it, and thinks she could sell it. She creates an Agent profile on the DLCD-SAP and is provided a personal commission code. She then acquires the one or more images of Ted's painting, along with a DLCD-SAP website link that she can use on her social media platforms. Lisa uploads the photo of Ted's painting to Instagram™, for example, letting people know that the painting is for sale, along with her personal DLCD-SAP commission code.

At the same time many hundreds of DLCD-SAP Agents could be doing the same thing with Ted's painting, giving him significant exposure compared to just promoting the painting on his own Instagram™ account or another website. Rick is following Lisa on Instagram™ and sees Ted's painting and would like to buy it. He clicks on a “Buy It Now” link that takes Rick to a DLCD-SAP portal. In order to purchase the painting Rick enters a DLCD-SAP commission code, in this instance as Rick saw the painting on Lisa's Instagram™ he enters Lisa's DLCD-SAP code. Although he is free to use any personal DLCD-SAP code he wishes but chooses hers because he saw the artwork there first and enjoys her content. Rick now has bought the painting, and it will be shipped to him by Ted as the Seller 320. As Lisa's personal DLCD-SAP code was the first of the Agent codes entered to buy the painting she gets the 10% commission (i.e. US$1,000). The commission is paid directly to Lisa based upon the one or more smart contract(s) associated with the DLCD-SAP posting from Ted and the posting by Lisa. The payment to Lisa being to a financial instrument of her choosing upon establishing a profile upon the DLCD-SAP to function as an Agent. The DLCD-SAP may also take a fixed fee or percentage based fee for managing the process which is again automatically managed through the smart contract(s). Optionally, the smart contract(s) perform financial aspects of the process by initially moving the funds from the Buyer (Rick) to a cryptocurrency account (commonly referred to as a cryptocurrency wallet or wallet), then moving the funds to other cryptocurrency accounts (wallets) (one each for Lisa, Ted and the DLCD-SAP) before the funds are then moved to their final destinations. However, if the Agent or Seller wishes the financial instrument associated with their profile may be a cryptowallet.

Accordingly, in this example Ted, Lisa or Rick do have to know each other personally or even trust each other as the smart contracts established by the DLCD-SAP broker the financial aspects of the process. Optionally, the financial transaction may be parsed in steps of limit fraud. For example, the initial movement of funds from the Buyer (Rick) to a cryptocurrency account may be performed to verify that the Buyer has paid. However, the subsequent steps may be held until another smart contract associated with a delivery of the product (painting) to the Buyer (Rick) is completed. This smart contract may involve a third party service provider, e.g. a shipping company or courier service for example. The shipping process may similarly exploit a digital ledger wherein the digital ledger includes images of the shipping process, e.g. pick up, delivery etc., as well as digital data relating to signatures, etc.

Whilst the exemplary processes are described and depicted with percentage based commissions it would be evident that within other embodiments of the invention the sale may be based upon fixed fee(s).

Whilst the exemplary processes are described and depicted with respect to a fixed sale price, it would be evident that within other embodiments of the invention the sale price may be variable according to a price an Agent can establish with a Buyer.

Within other embodiments of the invention with a variable sales price the Seller may establish a variable fixed fee or variable percentage based commission. For example, if the sale achieves less than a first threshold, a first fixed fee or first percentage is applied but, if the sale achieves more than the first threshold but less than a second threshold, a second fixed fee or second percentage is applied. Such a tiered fixed fee or percentage fee may have two, three or more tiers.

Now referring to FIG. 4 there is depicted an exemplary purchase Flow 400 supported by embodiments of the invention. As depicted Flow 400 comprises first to sixth Blocks 410 to 460 respectively. These comprising:
First Block 410 wherein the Buyer Payment is processed;
Second Block 420 wherein the DLCD-SAP Platform extracts one or more smart contracts associated with the product being purchased by the Buyer from one or more databases accessible to the DLCD-SAP;
Third Block 430 wherein the DLCD-SAP Platform parses the extracted one or more smart contracts to establish the financial instruments for the next step of distribution of the sale proceeds and the percentages/fees associated with the sale;
Fourth Block 440 wherein the DLCD-SAP Platform establishes and transfers the seller's portion of the sale to the financial instrument defined within the one or more smart contracts for the seller;
Fifth Block 450 wherein the DLCD-SAP Platform establishes and transfers the agent's portion of the sale to the financial instrument defined within the one or more smart contracts defined for the agent; and
Sixth Block 460 wherein the DLCD-SAP Platform establishes and transfers to the DLCD-SAP that portion of the sale to the financial instrument defined within the one or more smart contracts for the DLCD-SAP.

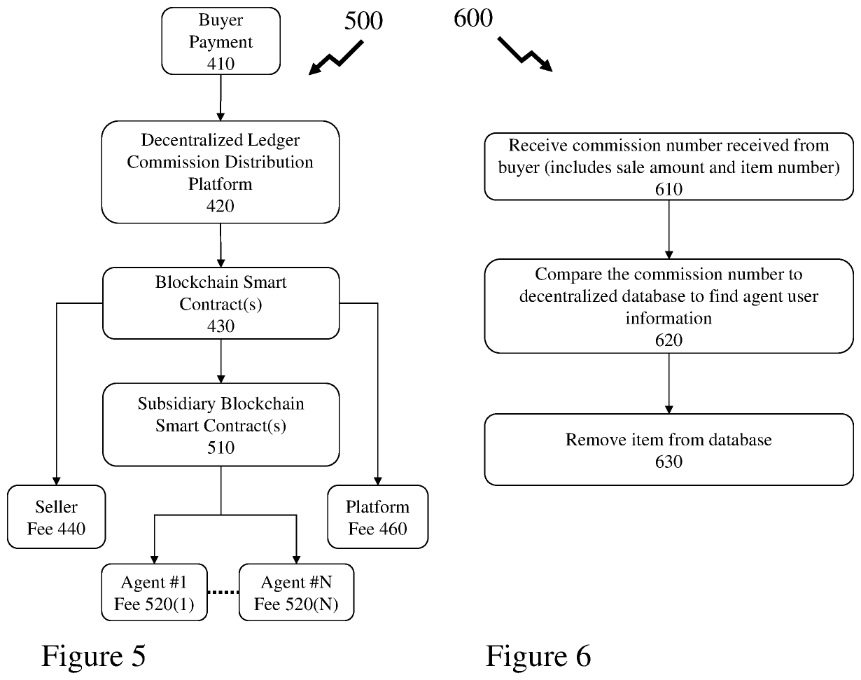

It would be evident that fifth Block 450 may, where the agent portion is two or more layers, distribute the agent portion of the sale to those within the different layers according to the terms of the smart contracts. Such an example, being depicted in FIG. 5 wherein an exemplary smart contract Flow 500 according to an embodiment of the invention. As depicted Flow 500 comprises:
First to fourth Blocks 410 to 440 respectively of Flow 400;
Sixth Block 460 of Flow 400; and
First Flow Block 510; and
Second to Nth Flow Blocks 520(1) to 520(N).

First Flow Block 510 relates to the DLCD-SAP establishing that there are subsidiary blockchain smart contracts associated with the main blockchain smart contract associated with the product in third Block 420. These subsidiary blockchain smart contracts being associated with Agents in other layers of the sales hierarchy as described above. Accordingly, the DLCD-SAP retrieves from the one or more databases the smart contracts associated with the Second to Nth Flow Blocks 520(1) to 520(N), parses them and executes the distribution of sale proceeds according to the terms of the smart contracts to the financial instruments associated with the agents Agent #1 to Agent #N.

Now referring to FIG. 6 there is depicted an exemplary Flow 600 for removal of an item for sale upon its purchase by a buyer. As depicted Flow 600 comprises first to third Blocks 610 to 630 respectively.
First Block 610 wherein the DLCD-SAP receives the commission number associated with the buyer's purchase, where this commission number may also be received with the sale amount and item number (as the sale amount may be variable rather than that defined by the seller);
Second Block 620 wherein the DLCD-SAP compares the commission number to one or more decentralized databases to find agent user information and therein the smart contract(s) associated with the sale; and
Third Block 630 wherein the DLCD-SAP compares the commission number to one or more decentralized databases to find the product and remove the product from the database.

If, the product is posted upon a website, social media, social network etc. associated with the DLCD-SAP then the DLCD-SAP can also in third Block 630 remove these postings or augment them with an indication that the item has been sold. Further, the DLCD-SAP may, where the metadata stored by the DLCD-SAP relating to the product indicates agents who are promoting the product, may notify the agents that the product has been sold so that they can remove it from the websites they are promoting the product upon. If the product has multiple items available, e.g. rather than a single painting the product is 150 prints, then the DLCD-SAP updates to agents may indicate the number sold and/or the number remaining.

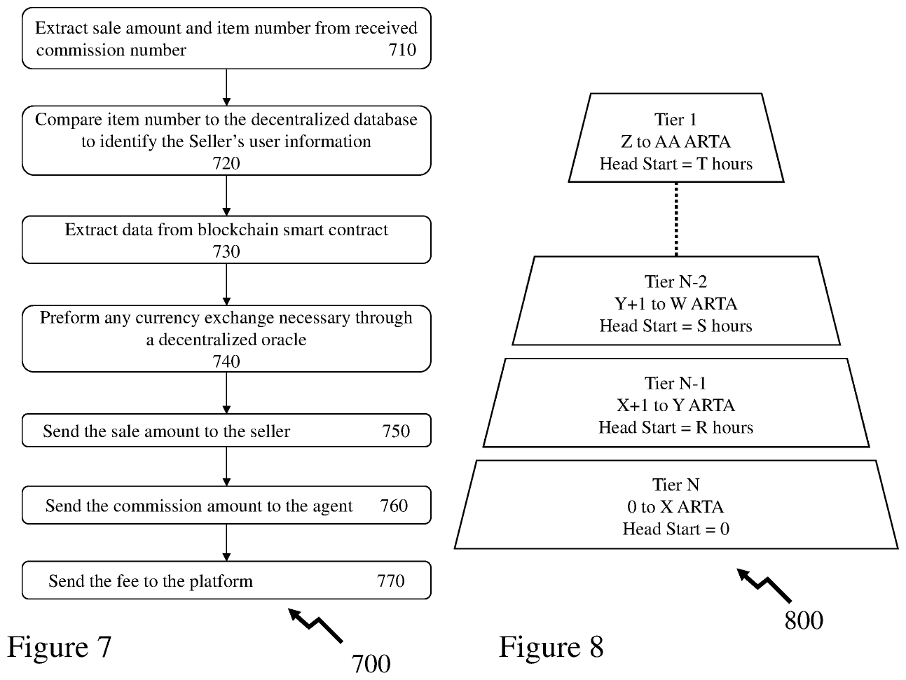

Referring to FIG. 7 there is depicted an exemplary Flow 700 for the processing of a sale based upon a smart contract associated with the item sold and the automated distribution of the sale proceeds. As depicted Flow 700 comprises first to seventh Blocks 710 to 770 respectively, these comprising:
First Block 710 wherein a sale amount and item number are extracted as associated with a received commission number associated with a purchase associated with a product sold through a DLCD-SAP;
Second Block 720 wherein the DLCD-SAP compares the item number to the decentralized databases of the DLCD-SAP to identify the seller's user information;
Third Block 730 wherein the DLCD-SAP extracts data from one or more blockchain smart contracts associated with the item number;
Fourth Block 740 wherein the DLCD-SAP performs any currency exchange(s) necessary through a decentralized oracle to convert the purchase currency to the currencies of the seller, agent, DLCD-SAP etc.;
Fifth Block 750 wherein the DLCD-SAP sends the sale amount to the seller;
Sixth Block 760 wherein the DLCD-SAP sends the commission amounts to the agent(s); and
Seventh Block 770 wherein the sends the platform fee to the DLCD-SAP account.

Now referring to FIG. 8 there is depicted an exemplary hierarchy of subsets of a crowdsourcing community wherein different subsets are able to offer a product or service for sale in advance of other subsets based upon their prior performance at selling. Within the preceding description an Agent promoting a product may be one agent of a plurality of agents promoting the product, a unique product or one product of a plurality of products. Within an embodiment of the invention agents seeking to promote a product or products may be grouped into different levels of a hierarchy where their association with a specific level of the hierarchy may be established in dependence upon one or more factors. These one or more factors may be selected from the group comprising a rating of the agent as defined by number of sales completed, a rating of the agent as defined by buyers who have bought from the agent, a value of products sold, a measure of duration of a product being promoted by the agent before sale, and a degree of separation of the agent from the seller.

Within FIG. 8 the rating of an agent is defined in an arbitrary unit, ARTA. As depicted in FIG. 8 with Hierarchy 800 is depicted comprising a plurality of tiers from Tier 1 through to Tier N where each tier is associated with a range of ratings. As depicted:
Tier 1 is associated with agents having ratings within the range Z to AA ARTA;
Tier N−2 is associated with agents having ratings within the range Y+1 to W ARTA;
Tier N−1 is associated with agents having ratings within the range X+1 to Y ARTA; and
Tier N is associated with agents having ratings within the range 0 to X ARTA.

When a seller establishes a product for sale then an agent may be provided with a head start against other agents in order to establish the opportunity to sell prior to other agents. As depicted in FIG. 8 an agent in Tier 1 is given a head start of T hours, an agent in Tier N−2 is given a head start of S hours, an agent in Tier N−1 is given a head start of R hours, and Tier N where the agent has no head start. When a seller places a product into the DLCD-SAP for sale then there may be an initial “offer” period wherein agents can sign-up to sell the product and the DLCD-SAP advises agents at the end of the offer period when they will be able to start promoting the product. Up until the time that the agent is able to offer the product the DLCD-SAP may block the agent from obtaining the unique DLCD-SAP commission number they would require for the DLCD-SAP to associate the agent to the smart contract(s) etc. so that they agent obtains their commission for a sale they broker.

Within another embodiment of the invention there may be no offer period but as agents “sign-up” to sell the product then other agents are “locked-out” for a period of time based upon the level of the agent “signing-up” but agents who have already started promoting are not blocked from continuing. Accordingly, for example agents in Tier N with no head start can be promoting and “joining-up” but a Tier N−2 agent promoting establishes a lock-out of other agents in lower tiers for a period up to S hours after the seller posted. A subsequent Tier 1 agent would be able to join and block all lower levels from initiating promotion for a period of T hours.

Within another embodiment of the invention the “head starts” are calculated not from the time the time at which the seller places the item for sale but from the time the agent registers to promote the item.

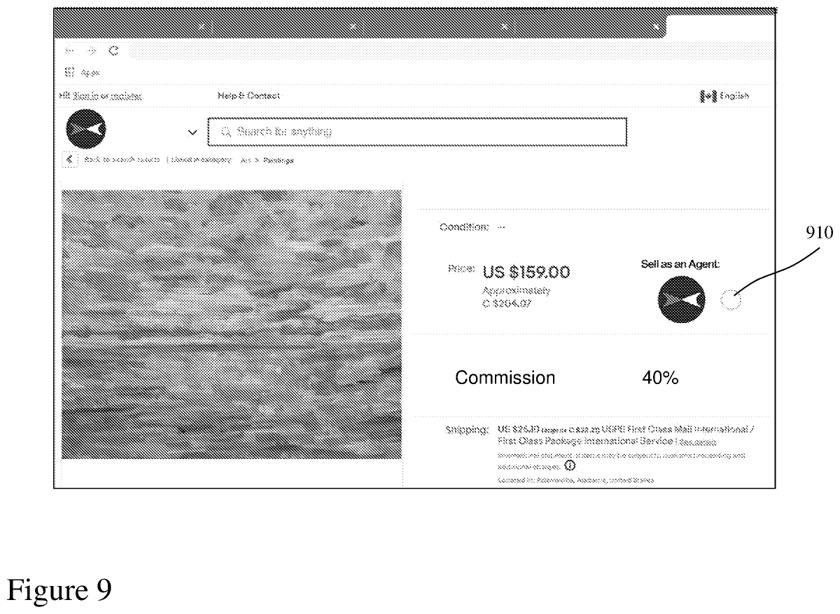

Referring to FIG. 9 there is depicted an exemplary DLCD-SAP storefront allowing a user to indicate that they wish to function as an agent for the sale of the product where the sale is managed through a smart contract held within a decentralized ledger. As depicted the user has navigated to a painting within a portal of the DLCD-SAP wherein they have the ability to sign up as an agent through Button 910.

Now referring to FIG. 10 there is depicted a hierarchy of smart contracts for sale of an item. At the lower most layer, Layer 0, is the seller. When an agent signs up to promote the item then an initial smart contract (Smart Contract $(1)) is established in Layer 1 “Direct Promotion” with a unique identity, DLCD-SAP-Identity(#1). If the agent then enables another agent to promote then a subsidiary smart contract (Smart Contract $(2)) is established in Layer 2 “In-Direct Promotion” with a unique identity, DLCD-SAP-Identity(#2). This process can continue to subsequent agents acting as sub-agents of sub-agents etc. to Level N in another “In-Direct Promotion” with an associated Smart Contract $(N) with its unique identity DLCD-SAP-Identity(#N).

Within an embodiment of the invention an agent seeking to promote may establish a direct promotion or an indirect promotion. In order for an agent to act in an indirect promotional role the previous agent in the hierarchy within embodiments of the invention would authorise the other agent to function as an indirect promotor.

As outlined above a DLCD-SAP according to an embodiment of the invention exploits a blockchain technology running a program or “smart contract” to ensure that the system is timely, immutable, and transparent to all participants.

Within an embodiment of the invention when a Buyer enters an Agent's commission number, the number is in turn entered into the smart contract. The program identifies the Agent and Seller and defines the transaction. As soon as the Buyer pays the fee, the smart contract is activated through the blockchain and every party is paid out at the same time. This action is completely transparent, immutable through the blockchain technology and verifiable through the blockchain technology.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of executing a sale comprising:
establishing an item for sale upon a web portal accessible to a group of users by a seller;
establishing by an agent an intent to promote the sale of the item in dependence upon an action by the agent with the web portal;
establishing upon another portal further content relating to the item wherein the further content is established by another action by the agent upon the web portal; and
establishing by a buyer an action with respect to the further content on the another portal to purchase the item; wherein
the agent is a user of the group of user;
the further content comprises a unique identifier associating the further content to the item; and
funds relating to the purchase of the item by the buyer are automatically distributed in dependence upon one or more smart contracts stored within a distributed ledger which are executed by a system associated with the web portal.

2. The method according to claim 1, wherein
a first portion of the funds are distributed to the seller;
a second portion of the funds are distributed to the agent; and
a third portion of the funds are distributed to the system associated with the web portal.

3. A method comprising:
automatically distributing funds relating to a sale of an item in dependence upon one or more smart contracts stored within a distributed ledger; wherein
the one or more smart contracts are established in dependence upon a unique identifier associated with the item for sale established by the system upon the item being listed for sale.

4. The method according to claim 3, wherein
a first portion of the funds are automatically distributed to the seller in dependence upon a smart contract of the one or more smart contracts upon a verification that payment of funds relating to a sale of the item for sale have been paid by a buyer of the item for sale;
a second portion of the funds are automatically distributed to the agent in dependence upon a smart contract of the one or more smart contracts upon the verification that payment of funds relating to the sale of the item for sale have been paid by the buyer of the item for sale; and
a third portion of the funds are automatically distributed to the system associated with the web portal upon the verification that payment of funds relating to the sale of the item for sale have been paid by the buyer of the item for sale.

5. The method according to claim 3, wherein
a first portion of the funds are automatically distributed to the seller in dependence upon a smart contract of the one or more smart contracts upon a verification that payment of funds relating to a sale of the item for sale have been paid by a buyer of the item for sale;
a second portion of the funds are automatically distributed to the agent in dependence upon a smart contract of the one or more smart contracts upon the verification that payment of funds relating to the sale of the item for sale have been paid by the buyer of the item for sale; and
a third portion of the funds are automatically distributed to the system associated with the web portal upon the verification that payment of funds relating to the sale of the item for sale have been paid by the buyer of the item for sale; and
the verification that payment of funds relating to the sale of the item for sale have been paid by the buyer of the item for sale is established by establishing at least one of another smart contract or an addition to an existing smart contract of the one or more smart contracts.

6. A system for managing an execution of a sale comprising:
a memory storing computer executable instructions for execution by a processor;
a server comprising the processor connected to a communications network;
one or more other servers also connected to the communications network; wherein
the instructions when executed by the processor configure the server to execute a process comprising the steps of:
establishing an item for sale upon a web portal accessible to a group of users by a seller;
establishing by an agent an intent to promote the sale of the item in dependence upon an action by the agent with the web portal;
establishing upon another portal further content relating to the item wherein the further content is established by another action by the agent upon the web portal; and
establishing by a buyer an action with respect to the further content on the another portal to purchase the item; wherein
the agent is a user of the group of user;
the further content comprises a unique identifier associating the further content to the item;
funds relating to the purchase of the item by the buyer are automatically distributed in dependence upon one or more smart contracts stored within a distributed ledger which are executed by a system associated with the web portal; and
the distributable ledger is hosted upon the one or more other servers.

7. The system according to claim 6, wherein
a first portion of the funds are distributed to the seller;
a second portion of the funds are distributed to the agent; and
a third portion of the funds are distributed to the system associated with the web portal.

8. A system for managing an execution of a sale comprising:
a memory storing computer executable instructions for execution by a processor;
a server comprising the processor connected to a communications network;
one or more other servers also connected to the communications network; wherein
the instructions when executed by the processor configure the server to execute a process comprising the step of automatically distributing funds relating to a sale of an item in dependence upon one or more smart contracts stored within a distributed ledger;
the one or more smart contracts are established in dependence upon a unique identifier associated with the item for sale established by the server upon the item being listed for sale;
the distributable ledger is hosted upon the one or more other servers.

9. The system according to claim 8, wherein
a first portion of the funds are automatically distributed to the seller in dependence upon a smart contract of the one or more smart contracts upon a verification that payment of funds relating to a sale of the item for sale have been paid by a buyer of the item for sale;
a second portion of the funds are automatically distributed to the agent in dependence upon a smart contract of the one or more smart contracts upon the verification that payment of funds relating to the sale of the item for sale have been paid by the buyer of the item for sale; and
a third portion of the funds are automatically distributed to the system associated with the web portal upon the verification that payment of funds relating to the sale of the item for sale have been paid by the buyer of the item for sale.

10. The system according to claim 8, wherein
a first portion of the funds are automatically distributed to the seller in dependence upon a smart contract of the one or more smart contracts upon a verification that payment of funds relating to a sale of the item for sale have been paid by a buyer of the item for sale;
a second portion of the funds are automatically distributed to the agent in dependence upon a smart contract of the one or more smart contracts upon the verification that payment of funds relating to the sale of the item for sale have been paid by the buyer of the item for sale; and
a third portion of the funds are automatically distributed to the system associated with the web portal upon the verification that payment of funds relating to the sale of the item for sale have been paid by the buyer of the item for sale; and
the verification that payment of funds relating to the sale of the item for sale have been paid by the buyer of the item for sale is established by establishing at least one of another smart contract or an addition to an existing smart contract of the one or more smart contracts.
